(19) United States
(12) Patent Application Publication
(10) Pub. No.: US 2012/0030649 A1
(43) Pub. Date: Feb. 2, 2012

(54) Methods and Systems for Automatic Generation of Multithread-Safe Software Code

(75) Inventor: Fernando Chapa, Harold, CA (US)

(73) Assignee: Advanced Bionics AG, c/o Froriep Renggli, Zug (CH)

(21) Appl. No.: 12/848,523

(22) Filed: Aug. 2, 2010

(51) Int. Cl. G06F 9/44

(52) U.S. Cl. 717/106

(57) ABSTRACT

An exemplary method of automatic generation of multithread-safe software code includes a multithread-safe code generator subsystem analyzing data representative of non-multithread-safe software code and automatically generating data representative of multithread-safe software code based on the analyzing of the data representative of the non-multithread-safe software code. Corresponding methods and systems are also described.

### BACKGROUND INFORMATION

The natural sense of hearing in human beings involves the use of hair cells in the cochlea that convert or transduce acoustic signals into auditory nerve impulses. Hearing loss, which may be due to many different causes, is generally of two types: conductive and sensorineural. Conductive hearing loss occurs when the normal mechanical pathways for sound to reach the hair cells in the cochlea are impeded. These sound pathways may be impeded, for example, by damage to the auditory ossicles. Conductive hearing loss may often be overcome through the use of conventional hearing aids that amplify sound so that acoustic signals can reach the hair cells within the cochlea. Some types of conductive hearing loss may also be treated by surgical procedures.

Sensorineural hearing loss, on the other hand, is caused by the absence or destruction of the hair cells in the cochlea which are needed to transduce acoustic signals into auditory nerve impulses. People who suffer from sensorineural hearing loss may be unable to derive significant benefit from conventional hearing aid systems, no matter how loud the acoustic stimulus. This is because the mechanism for transducing sound energy into auditory nerve impulses has been damaged. Thus, in the absence of properly functioning hair cells, auditory nerve impulses cannot be generated directly from sounds.

To overcome sensorineural hearing loss, numerous cochlear implant systems—or cochlear prostheses—have been developed. Cochlear implant systems bypass the hair cells in the cochlea by presenting electrical stimulation directly to the auditory nerve fibers by way of one or more channels formed by an array of electrodes implanted in the cochlea. Direct stimulation of the auditory nerve fibers leads to the perception of sound in the brain and at least partial restoration of hearing function.

When a cochlear implant of a cochlear implant system is initially implanted in a patient, and during follow-up tests and checkups thereafter, it is usually necessary to fit the cochlear implant system to the patient. Fitting of a cochlear implant system to a patient is typically performed by an audiologist or the like who utilizes a fitting system to present various stimuli to the patient and relies on subjective feedback from the patient as to how such stimuli are perceived.

A fitting system typically includes fitting software (e.g., a fitting software application) that executes on at least one computing device that is communicatively coupled to a cochlear implant system. The fitting software may direct the computing device and/or the communicatively coupled cochlear implant system to perform one or more fitting procedures designed to fit the cochlear implant system to the patient. For a patient who has a separate cochlear implant system for each ear (i.e., a “bilateral patient”), the computing device may be communicatively coupled to both of the cochlear implant systems, and the fitting software may direct the computing device and/or the communicatively coupled cochlear implant systems to perform one or more fitting procedures.

The operations of the fitting software may utilize and/or require access to multiple resources, including one or more processors of the computing device, memory of the computing device (e.g., a database maintained in memory of the computing device), any communicatively coupled cochlear implant systems, user interface resources, and any hardware used to communicatively couple the computing device to one or more cochlear implant systems. However, servicing the needs of such resources may be time consuming and may undesirably affect execution of the fitting software. For example, servicing the hardware of any communicatively coupled cochlear implant systems and/or a database associated with the fitting software may cause a user interface of the fitting software to become non-responsive while the hardware and/or database are being serviced.

To avoid such problems, multithreading may be employed by the fitting software in order to enhance the capability of the fitting system to concurrently perform multiple operations and/or service multiple resources. Multithreading generally involves organizing operations to be performed by the fitting system into logical groups referred to as threads that may be executed concurrently and independently by one or more processors.

While multithreading allows multiple threads to be executed concurrently and independently, multithreading also introduces inherent reliability risks. As an example, if not created properly, multithreading software code can introduce what are commonly known as race conditions that occur when multiple threads of execution attempt to concurrently execute the same task in a way that produces unpredictable results, such as when the order in which steps of the threads are executed is dependent on timing and/or device characteristics. As another example, if not created properly, multithreading software code can introduce what are commonly known as deadlocks that occur when multiple threads of execution attempt to access the same resources but end up waiting indefinitely for the resources to become available.

Because of these and other potential problems associated with multithreading, the development of reliable multithreading software code is significantly more complex than the development of non-multithreading software code. For example, computer programmers who are experienced in writing non-multithreading software code often lack experience and/or skills for writing reliable multithreading software code. In addition, opportunities for computer programmers to introduce problems into software code increase significantly when the computer programmers are creating multithreading software code. The testing of hand-generated multithreading software code is also more complex, difficult, and time consuming than the testing of non-multithreading software code. Accordingly, the use of multithreading software code typically increases the costs and time required to develop and test the software code, as well as the risk of the software code having problems with reliability.

### SUMMARY

An exemplary method of automatic generation of multithread-safe software code includes a multithread-safe code generator subsystem 1) analyzing data representative of non-multithread-safe software code and 2) automatically generating data representative of multithread-safe software code based on the analyzing of the data representative of the non-multithread-safe software code.

Another exemplary method of automatic generation of multithread-safe software code includes a multithread-safe code generator subsystem 1) detecting a class that is included in software code and that is to be made multithread safe, 2) analyzing the class, 3) automatically generating, based on the analyzing of the class, a proxy class that derives from the class, wherein the proxy class includes multithread protection code that is configured to make the proxy class a multithread-safe version of the class, and 4) implementing the proxy class in the software code.

An exemplary system for automatic generation of multithread-safe software code includes 1) a code analysis facility configured to analyze software code representative of a non-multithread-safe version of a cochlear implant fitting software application and 2) a code generation facility communicatively coupled to the code analysis facility and configured to automatically generate, based on the analysis, data representative of a multithread-safe version of the cochlear implant fitting software application.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary system for automatic generation of multithread-safe software code according to principles described herein.

FIG. 2 illustrates exemplary components of an exemplary multithread-safe code generator subsystem according to principles described herein.

FIG. 3 illustrates an exemplary method for automatic generation of multithread-safe software code according to principles described herein.

FIG. 4 illustrates another exemplary method for automatic generation of multithread-safe software code according to principles described herein.

FIG. 5 illustrates another exemplary method for automatic generation of multithread-safe software code according to principles described herein.

FIG. 6 illustrates exemplary pseudocode representing an exemplary element of non-multithread-safe software code.

FIG. 7 illustrates exemplary pseudocode representing an exemplary multithread-safe version of the element of non-multithread-safe software code shown in FIG. 6.

FIG. 8 illustrates an exemplary cochlear implant fitting system according to principles described herein.

FIG. 9 illustrates an exemplary implementation of the cochlear implant fitting system of FIG. 8 according to principles described herein.

FIG. 10 illustrates an exemplary computing device according to principles described herein.

### DETAILED DESCRIPTION

Methods and systems for automatic generation of multithread-safe software code are described herein. As described in more detail below, a multithread-safe code generator subsystem may be configured to analyze data representative of non-multithread-safe software code and automatically generate data representative of multithread-safe software code based on the analysis of the data representative of the non-multithread-safe software code.

As used herein, the term “multithread-safe software code” (or simply “multithread-safe code”) refers to software code that is capable of multithreading and that includes multithread protection code configured to protect against one or more problems (e.g., software bugs) that may otherwise be introduced by multithreading absent the multithread protection code. The term “non-multithread-safe software code” (or simply “non-multithread-safe code”) refers to software code that is not multithread-safe software code. For example, non-multithread-safe software code may include software code that is not configured for multithreading or that does not include multithread protection code configured to protect against one or more problems that may be introduced by multithreading absent the multithread protection code.

Numerous advantages may be associated with the methods and systems described herein. For example, non-multithread-safe software code may be developed in accordance with standard software development practices. The non-multithread-safe software code may then be subjected to processing by a multithread-safe code generator subsystem, which may analyze the non-multithread-safe software code and, based on the analysis, automatically generate multithread-safe software code that includes multithread protection code configured to protect against one or more problems that may have otherwise been introduced by multithreading absent the multithread protection code. Such a process for automatic generation of multithread-safe software code may avoid the costs, time requirements, complicated testing, and/or reliability risks associated with hand-generation of multithreading software code.

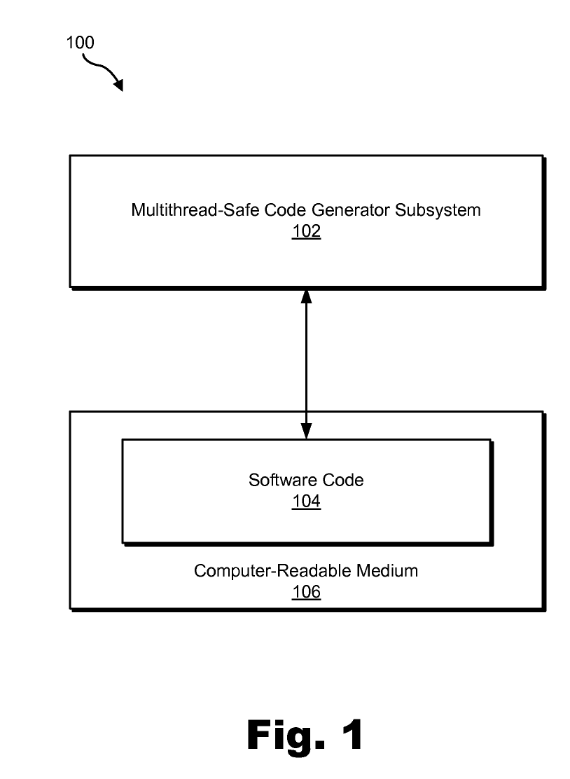

To facilitate an understanding of the methods and systems described herein, an exemplary system 100 configured for automatic generation of multithread-safe software code will be described in connection with FIG. 1. As shown in FIG. 1, system 100 may include a multithread-safe code generator subsystem 102 (or simply “subsystem 102”) configured to interact with software code 104. As described in more detail herein, subsystem 102 may analyze software code 104 and automatically generate, based on the analysis of software code 104, multithread-safe software code.

Software code 104 may include data representative of any form or type of software code, including, without limitation, a software application, a section of a software application, source code, compiled code (e.g., compiled binary operation codes (“opcodes”)), intermediate level code, machine language code, assembly code, and any element, combination, and/or sub-combination thereof. In certain implementations described further below, software code 104 may include data representative of a cochlear implant fitting software application.

Software code 104 may include non-multithread-safe code. In certain examples, software code 104 may additionally or alternatively include multithread-safe code generated by subsystem 102. For example, subsystem 102 may analyze software code 104 that is non-multithread safe and automatically generate multithread-safe code by adding multithread-safe code to software code 104 (e.g., by inserting multithread protection code into software code 104) and/or by otherwise modifying software code 104 to become multithread safe (e.g., by replacing non-multithread-safe code in software code 104 with multithread-safe code). In this or a similar manner, software code 104 may be converted from being non-multithread safe to being multithread safe in some examples. In alternative examples, subsystem 102 may generate multithread-safe software code that is separate from software code 104 based on analysis of software code 104.

Software code 104 may include one or more elements, including any elements that are typically part of software code. For example, software code 104 may include one or more classes, objects, methods, parameters, calls, statements, data structures, etc. The particular element included in software code 104 may depend on a number of factors, including, without limitation, a programming language, a software development environment, a software execution environment, and a purpose of software code 104. Elements of software code 104 used in exemplary implementations will be described in detail further below. However, the exemplary implementations are illustrative. The exemplary methods and systems may be applied to other implementations, including implementations in which software code 104 includes alternative and/or additional elements.

As shown in FIG. 1, data representative of software code 104 may be stored on a computer-readable medium 106 (also referred to as a processor-readable medium), which may include any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

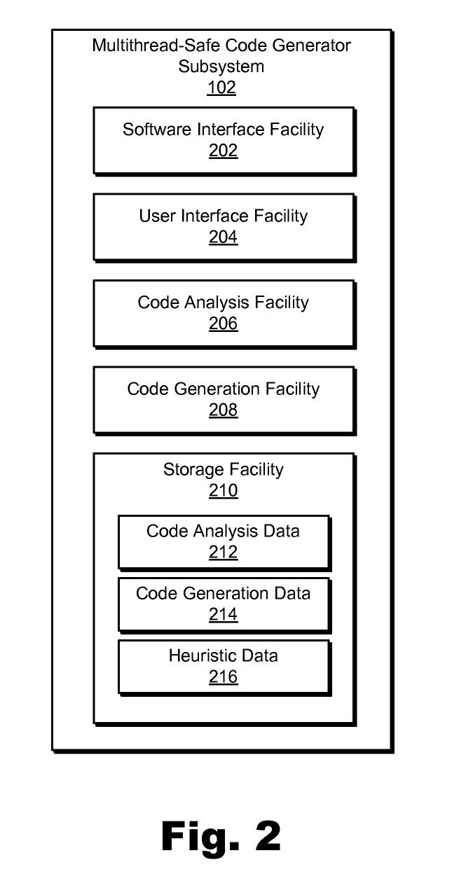

As mentioned, subsystem 102 may be configured to analyze software code 104 and automatically generate, based on the analysis of software code 104, multithread-safe software code. To help facilitate and understanding of subsystem 102, FIG. 2 illustrates exemplary components of subsystem 102. As shown in FIG. 2, subsystem 102 may include a software interface facility 202, a user interface facility 204, a code analysis facility 206, a code generation facility 208, and a storage facility 210, which may be communicatively coupled to one another using any suitable communication technologies. Each of these facilities will now be described in more detail.

Software interface facility 202 may be configured to facilitate interaction of subsystem 102 with software code 104. To this end, software interface facility 202 may include any interface technologies (e.g., one or more application program interfaces) suitable for enabling subsystem 102 to interact with software code 104 such that subsystem 102 is able to analyze and/or modify software code 104 in any of the ways described herein. Software interface facility 202 may also include any technologies suitable for enabling subsystem 102 to communicate with computer-readable medium 106 and/or any computing devices in order to access software code 104.

User interface facility 204 may be configured to provide one or more user interfaces configured to facilitate user interaction with subsystem 102. For example, user interface facility 204 may provide a graphical user interface (“GUI”) through which one or more functions, options, and/or features associated with one or more operations of subsystem 102 described herein may be provided to a user and through which user input may be received. In certain embodiments, user interface facility 204 may be configured to provide the GUI to a display device (e.g., a computer monitor) for display.

Code analysis facility 206 may be configured to perform one or more code analysis operations to analyze software code 104 in any of the ways described herein. As an example, code analysis facility 206 may be configured to detect one or more elements (e.g., classes, calls configured to instantiate instances of elements, etc.) in software code 104 that are to be made multithread safe. An element in software code 104 that is to be made multithread safe may be detected by code analysis facility 206 in any suitable way. In certain implementations, for example, software code 104 may include one or more markers indicating one or more elements that are to be made multithread safe. The markers may be in any form that can be detected by code analysis facility 206. For instance, an element may include a class defined in software code 104, and the class may be tagged with a marker (e.g., by tagging the class with an attribute, naming the class a particular way, defining the class to be a particular type of class, or any other suitable way). Subsystem 102 may be configured to detect the marker in any suitable way, such as by performing code introspection on software code 104.

Code analysis facility 206 may be further configured to analyze the detected elements that are to be made multithread safe. The detected element may be analyzed by content analysis facility 206 in any suitable way. For instance, code analysis facility 206 may analyze one or more properties, fields, methods, parameters, structures, and/or any other content included in or otherwise associated with the detected elements. As described further below, analysis of a detected element may be used by code generation facility 208 to automatically generate a multithread-safe version of the element.

Code analysis facility 206 may be further configured to detect one or more calls that are included in software code 104 and that are configured to instantiate one or more instances of the detected elements that are to be made multithread safe. For example, where an element to be made multithread safe includes a class, a call configured to instantiate an object of the class may be detected by code analysis facility 206. The detection may be made in any suitable way. As described further below, the detection of a call configured to instantiate an instance of an element to be made multithread safe may be utilized by code generation facility 208 to generate multithread-safe code.

Code analysis facility 206 may be further configured to store any data generated from the analysis of software code 104 in storage facility 210 as code analysis data 212. Code analysis data 212 may include any data representative of or otherwise associated with an analysis of software code 104 by code analysis facility 206. For example, code analysis data 212 may include data representative of one or more detected elements that are to be made multithread safe, data representative of analysis of the detected elements, and/or data representative of detected calls configured to instantiate one or more instances of the detected elements.

Code generation facility 208 may be configured to perform one or more code generation operations described herein to automatically generate multithread-safe software code. Code generation facility 208 may be configured to automatically generate the multithread-safe software code in any suitable way. For example, code generation facility 208 may generate new software code that is multithread safe based on an analysis of non-multithread-safe software code performed by code analysis facility 206. Additionally or alternatively, code generation facility 208 may be configured to modify the analyzed non-multithread-safe software code to make the code multithread safe. The modification may be performed in any suitable way, including, for example, by generating and adding multithread protection code to the non-multithread-safe code analyzed by code analysis facility 206.

The automatic generation of multithread-safe software code may include code generation facility 208 automatically generating one or more multithread-safe versions of elements that have been identified by code analysis facility 206 as elements that are to be made multithread safe. In certain examples, a multithread-safe version of an element may be derived from the element such that the multithread-safe version inherits one or more properties of the element. In addition, the multithread-safe version of the element may include multithread protection code configured to protect against one or more multithreading problems that may otherwise occur absent the multithread protection code. Code generation facility 208 may be configured to generate such multithread protection code based on an analysis of the element performed by code analysis facility 206 and to insert data representative of the multithread protection code into the multithread-safe version of the element. Examples of multithread protection code will be described further below.

In certain implementations, a multithread-safe version of an element may include a proxy version of the element. For example, where the element includes a class, code generation facility 208 may generate a multithread safe version of the class in the form of a new proxy class that derives from the class. The proxy class may be generated to include multithread protection code configured to protect against one or more multithreading problems that may otherwise occur absent the multithread protection code.

In certain implementations, the automatic generation of multithread-safe code may including code generation facility 208 replacing any calls in software code 104 that are configured to instantiate one or more instances of the elements identified by code analysis facility 206 as elements that are to be made multithread safe with one or more new calls that are configured to instantiate multithread-safe versions of the instances of the elements. For example, a call to instantiate an object of a class may be replaced by a new call to instantiate an object of a multithread-safe version of the class (e.g., a proxy class).

Code generation facility 208 may be configured to generate and store data representative of generated multithread-safe code and/or data used to generate multithread-safe code in storage facility 210 as code generation data 214. Code generation data 214 may include any data representative of or otherwise associated with automatic generation of multithread-safe code by code generation facility 208.

Storage facility 210 may be configured to maintain code analysis data 212, code generation data 214, and multithread protection heuristic data 216. Multithread protection heuristic data 216 (or simply “heuristic data 216”), which may be defined in advance of subsystem 102 analyzing software code 104 and automatically generating multithread-safe code, may represent one or more templates that may be used for automatic generation of multithread protection code based on analysis of software code 104. For example, heuristic data 216 may be utilized by code generation facility 208 to select a particular protection strategy (from a group of multiple protection strategies) and/or a particular form, type, or template of multithread protection code to implement in multithread-safe code based on the analysis performed by code analysis facility 206. Storage facility 210 may be configured to maintain additional or alternative data as may serve a particular implementation.

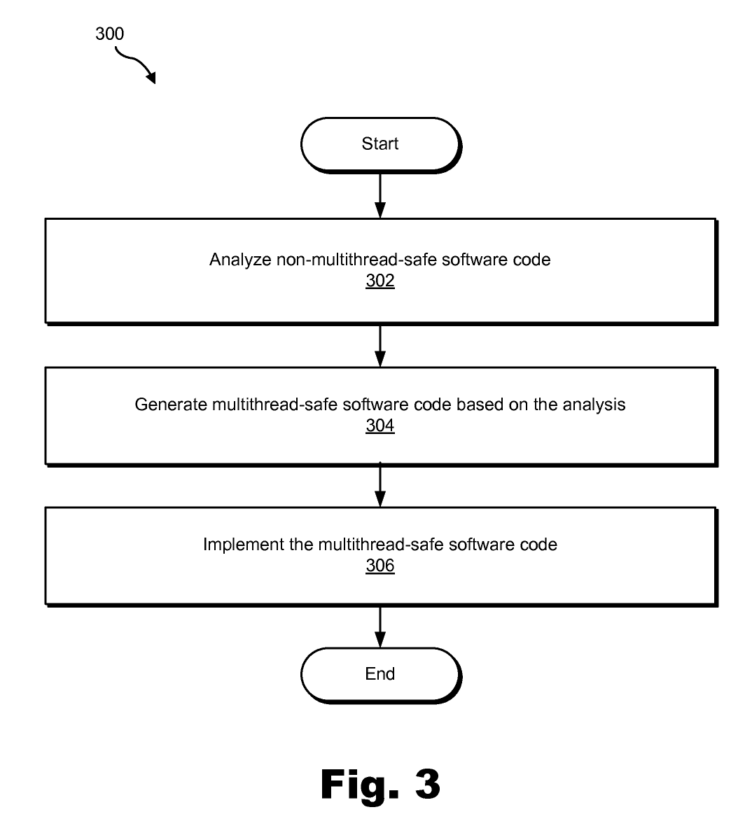

FIG. 3 illustrates an exemplary method 300 for automatic generation of multithread-safe software code. While FIG. 3 illustrates exemplary steps according to one embodiment, other embodiments may omit, add to, reorder, combine, and/or modify any of the steps shown in FIG. 3. One or more of the steps shown in FIG. 3 may be performed by any component or combination of components of subsystem 102.

In step 302, non-multithread-safe software code may be analyzed. For example, subsystem 102 may analyze non-multithread-safe software code in any of the ways described herein. The analysis may be performed by subsystem 102 automatically without human intervention.

In step 304, multithread-safe software code may be generated based on the analysis performed in step 302. For example, subsystem 102 may generate multithread-safe software code based on the analysis in step 302 in any of the ways described herein. The generation of the multithread-safe software code may be performed by subsystem 102 automatically without human intervention.

In step 306, the multithread-safe code generated in step 304 may be implemented. For example, subsystem 102 may modify data representative of non-multithread-safe software code to include the multithread-safe code such that the software code is made multithread safe. The modification may be performed in any suitable way, such as by subsystem 102 inserting multithread-safe code into the non-multithread-safe software code and/or replacing parts of the non-multithread-safe software code with multithread-safe code. Alternatively, subsystem 102 may generate data representative of new software code (e.g., a new software application) that includes the multithread-safe code.

To further illustrate method 300, exemplary implementations will now be described. The exemplary implementations are illustrative only. Method 300 and/or subsystem 102 may be implemented differently as may suit another implementation.

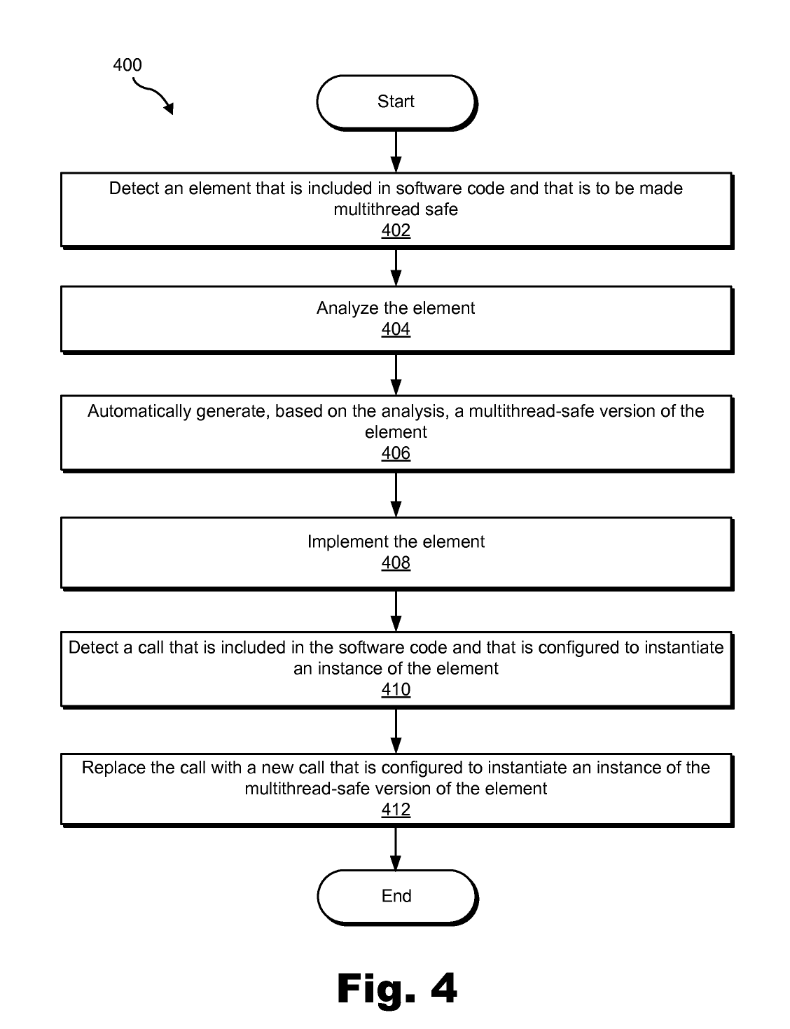

FIG. 4 illustrates another exemplary method 400 for automatic generation of multithread-safe software code. While FIG. 4 illustrates exemplary steps according to one embodiment, other embodiments may omit, add to, reorder, combine, and/or modify any of the steps shown in FIG. 4. One or more of the steps shown in FIG. 4 may be performed by any component or combination of components of subsystem 102.

In step 402, an element that is included in software code (e.g., software code 104) and that is to be made multithread safe may be detected. For example, subsystem 102 may search the software code for any elements in software code 104 that are to be made multithread safe. From the search, subsystem 102 may detect an element that is to be made multithread safe. The element may be detected by subsystem 102 in any suitable way, including in any of the ways described herein. For example, the element may be marked in the software code as an element that is to be made multithread safe.

In step 404, the element may be analyzed. For example, subsystem 102 may analyze the content of the element. The analysis may be performed in any way suitable to identify one or more attributes of the element that may be used to automatically generate a multithread-safe version of the element. In certain implementations, the analysis of the element in step 404 may include identifying any entry points into the element. For example, one or more components of the element may be accessible to calls that originate external to the element. Such externally accessible components may be identified as entry points. One or more attributes of each entry point (e.g., any passed and/or return parameters of an externally accessible method in the element) may be further analyzed by subsystem 102 for use in generating multithread protection code that may be applied to the entry point to generate a multithread-safe version of the element.

To illustrate, where the element includes a class defined in the software code, entry points to the class may include any methods in the class that are defined as “public” methods. One or more attributes of each public method (e.g., any passed and/or return parameters of the method) may be further analyzed for use in generating multithread protection code for each public method in order to generate a multithread-safe proxy class that derives from the class. An example of a multithread-safe proxy class that include multithread protection code will be described in detail further below.

In step 406, a multithread-safe version of the element may be automatically generated based on the analysis in step 404. For example, subsystem 102 may automatically generate, based on the analysis, a multithread-safe version of the element. The multithread-safe version of the element may inherit one or more attributes of the element. In addition, the multithread-safe version of the element may include multithread protection code configured to protect against one or more multithreading problems that may otherwise occur during execution of the software code absent the multithread protection code.

In step 408, the multithread-safe version of the element may be implemented. For example, subsystem 102 may modify data representative of non-multithread-safe software code to include data representative of the multithread-safe version of the element. The modification may be performed in any suitable way, such as by subsystem 102 inserting data representative of the multithread-safe version of the element into the non-multithread-safe software code and/or replacing parts of the non-multithread-safe software code. In certain implementations, subsystem 102 may generate and insert a module including data representative of the multithread-safe version of the element into the software code. The module may be in any suitable form. For example, the module may include a dynamic linked library (“DLL”) that includes compiled code configured to be dynamically loaded as needed during execution of the software code.

Typically, the multithread-safe version of the element and the non-multithread-safe version of the element may coexist and cooperate in the software code to make the software code multithread safe. For example, the multithread-safe version of the element may override and/or leverage one or more attributes of the non-multithread-safe version of the element. In certain examples, the software code may include a module having data representative of the element and may be modified to include another module having data representative of the multithread-safe version of the element.

In step 410, a call that is included in the software code and that is configured to instantiate an instance of the element may be detected. For example, subsystem 102 may search the software code for any calls configured to instantiate the element detected in step 402 and from the search may detect the call. The call may be detected by subsystem 102 in any suitable way.

In step 412, the call detected in step 410 may be replaced, in the software code, with a new call that is configured to instantiate an instance of the multithread-safe version of the element generated in step 406. Accordingly, when the software code is executed, an instance of the multithread-safe version of the element will be instantiated instead of an instance of the non-multithread-safe version of the element. In certain implementations, the instantiation of the multithread-safe version of the element instead of an instance of the non-multithread-safe version of the element may be transparent to one or more other elements of the software code and/or to a computing device executing the software code.

One or more steps in method 400 may be repeated for each element in software code that is to be made multithread safe. Execution of method 400 by subsystem 102 for each element that is to be made multithread safe automatically generates multithread-safe software code based on an analysis of non-multithread-safe software code.

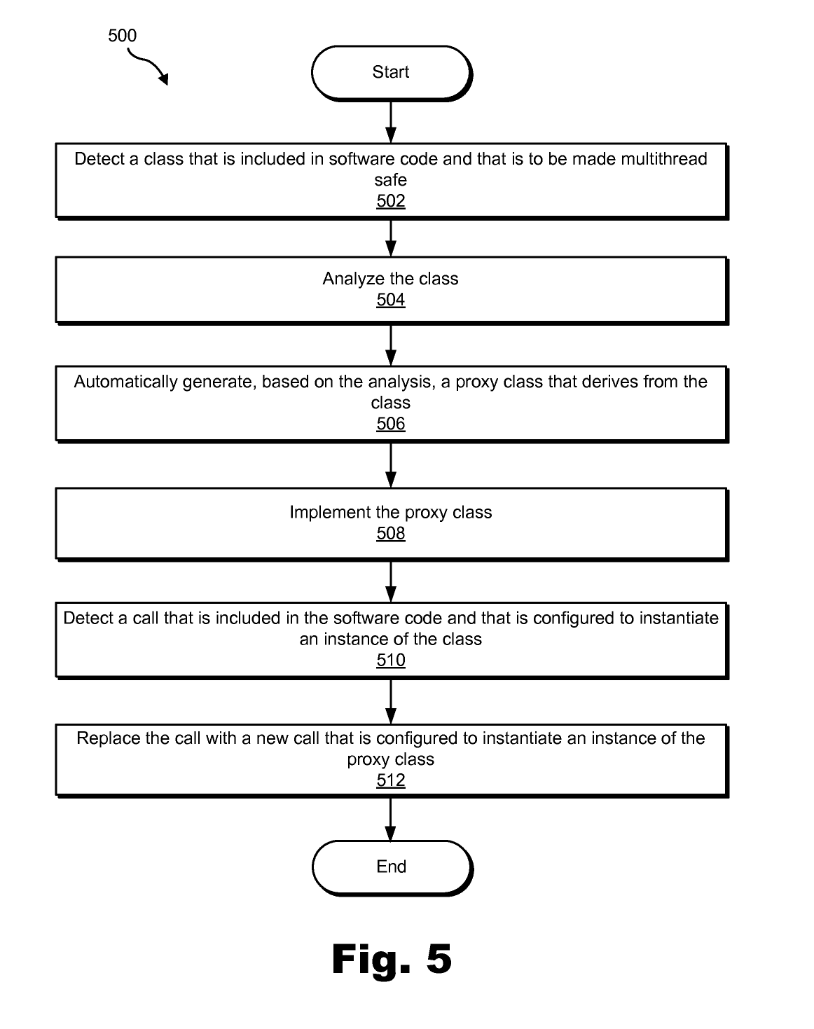

An exemplary implementation of method 400 in which a detected element in the software code includes a class will now be described in connection with FIG. 5. FIG. 5 illustrates another exemplary method 500 for automatic generation of multithread-safe software code. While FIG. 5 illustrates exemplary steps according to one embodiment, other embodiments may omit, add to, reorder, combine, and/or modify any of the steps shown in FIG. 5. One or more of the steps shown in FIG. 5 may be performed by any component or combination of components of subsystem 102.

In step 502, a class that is included in software code (e.g., software code 104) and that is to be made multithread safe may be detected. For example, subsystem 102 may search the software code for any elements that are to be made multithread safe. From the search, subsystem 102 may detect a class that is to be made multithread safe. The class may be detected by subsystem 102 in any suitable way, including in any of the ways described herein. For example, the class may be tagged with metadata indicating that the class is to be made multithread safe.

In step 504, the class may be analyzed. For example, subsystem 102 may analyze the content of the class. The analysis may be performed in any way suitable to identify one or more attributes of the class that may be used to automatically generate a proxy class that derives from the class. For example, subsystem 102 may analyze content of the class, such as any variables, fields, methods, and/or other attributes defined by the class. As mentioned, the analysis may include identifying and analyzing any entry points into the class (e.g., any “public” methods included in the class).

In step 506, a proxy class that derives from the class may be automatically generated based on the analysis in step 504. For example, subsystem 102 may automatically generate, based on the analysis, a proxy class that derives from the class. Accordingly, the proxy class may inherit one or more attributes of the class. In addition, as part of step 506, subsystem 102 may automatically generate and insert multithread protection code (e.g., a multithread-safe method) in the proxy class such that the proxy class is multithread safe. Examples of such multithread protection code will be described further below.

In step 508, the proxy class may be implemented. For example, subsystem 102 may modify data representative of non-multithread-safe software code to include data representative of the proxy class. The modification may be performed in any suitable way, such as by subsystem 102 inserting data representative of the proxy class into the non-multithread-safe software code and/or replacing parts of the non-multithread-safe software code. In certain implementations, subsystem 102 may generate and insert a module including data representative of the proxy class into the software code. The module may be in any suitable form. For example, the module may include a DLL that includes compiled code configured to be dynamically loaded as needed during execution of the software code.

Typically, the proxy class and the class from which the proxy class derives may coexist and cooperate in the software code to make the software code multithread safe. For example, the proxy class may be configured to override and/or leverage one or more attributes of the class from which it derives. In certain examples, the software code may include a DLL having data representative of the class and may be modified to include another DLL having data representative of the proxy class.

In step 510, a call that is included in the software code and that is configured to instantiate an instance of the class may be detected. For example, subsystem 102 may search the software code for any calls configured to instantiate the class detected in step 502 and from the search may detect the call. The call may be detected by subsystem 102 in any suitable way.

In step 512, the call detected in step 510 may be replaced, in the software code, with a new call that is configured to instantiate an instance of the proxy class generated in step 506. Accordingly, when the software code is executed, an instance of the proxy class will be instantiated instead of an instance of the class from which the proxy class derives. In certain implementations, the instantiation of the proxy class instead of an instance of the class from which the proxy class derives may be transparent to one or more other elements of the software code and/or to a computing device executing the software code.

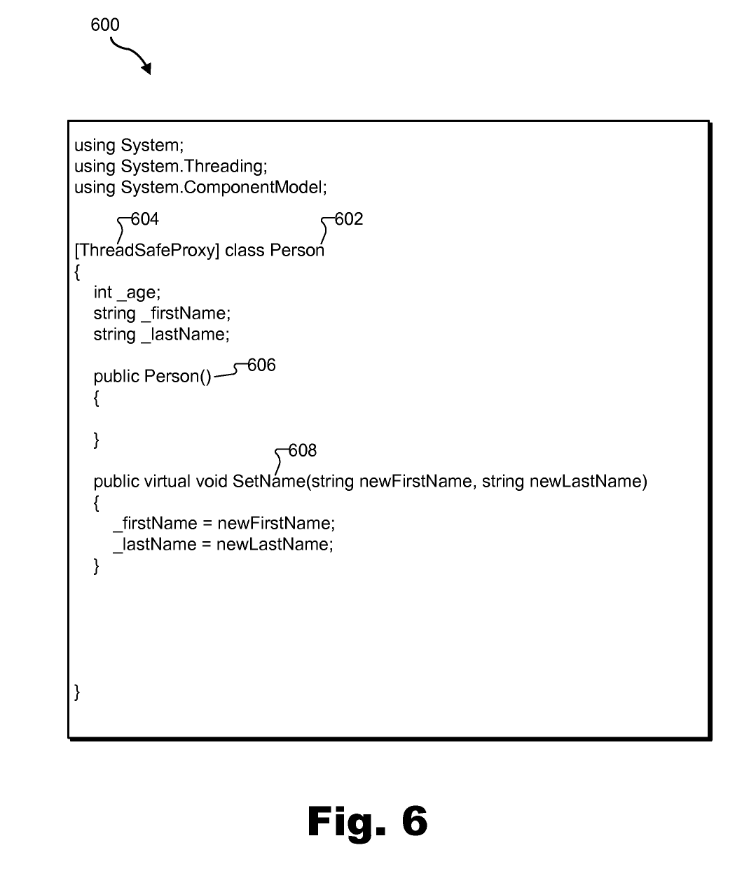

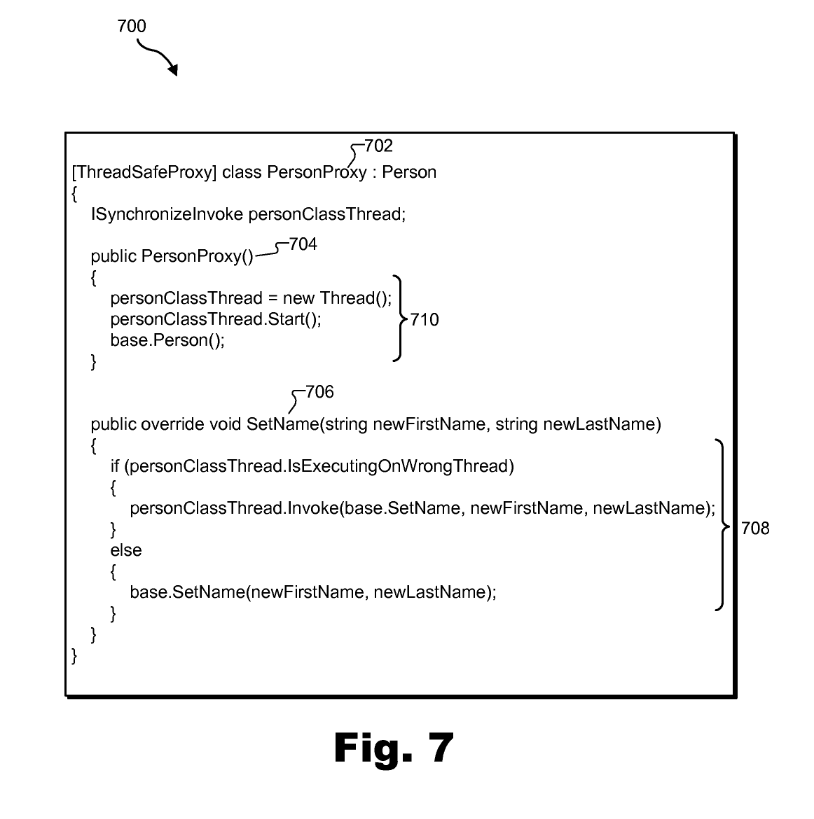

FIGS. 6-7 illustrate pseudocode defining exemplary classes that may be included in software code. To facilitate explanation of automatic generation of multithread-safe software code in connection with the classes, the classes represented in FIGS. 6-7 may be simplified and/or partial versions of classes included in software code. The classes may make calls to appropriate libraries as may suit a particular implementation. FIG. 6 illustrates pseudocode 600 defining a class 602 that is non-multithread safe and is tagged with a marker 604 indicating that the class is to be made multithread safe. FIG. 7 illustrates pseudocode 700 defining a proxy class 702 that derives from class 602, is multithread safe, and may be automatically generated by subsystem 102 as described herein. Each of the classes 602 and 702 will now be described in detail.

As shown in FIG. 6, class 602 may be named “Person” and may be tagged with marker 604 (e.g., a metadata marker) named “[ThreadSafeProxy]” and indicating that class 602 is to be made multithread safe by way of a multithread-safe proxy of class 602. Class 602 may define one or more methods, including a public constructor 606 named “Person” that is configured to be called to instantiate an instance of class 602 and a public virtual method 608 named “SetName” that is configured to be called to set values of variables named “_firstName” and “_lastName” to values indicated by parameters named “newFirstName” and “newLastName” that are passed to method 608.

As shown in FIG. 7, class 702 may be named “PersonProxy” and may be a proxy class that derives from class 602. Accordingly, class 702 may inherit attributes of class 602. Class 702 may define methods that correspond to (e.g., have the same or similar name as and/or are otherwise associated with) the methods of claim 602. For example, class 702 may define a public constructor 704 named “PersonProxy” that is configured to be called to instantiate an instance of class 702 and a public override method 706 named “SetName” that is configured to be call the corresponding “SetName” method of claim 602 to set values of variables named “_firstName” and “_lastName” to values indicated by parameters named “newFirstName” and “newLastName” that are passed to method 706.

Method 706 in class 702 may be configured to override method 608 in class 602. Accordingly, anytime a call is made to method 608 during execution of software code containing classes 602 and 702, method 706 may be given first opportunity to execute. In the example illustrated in FIGS. 6 and 7, the overriding is accomplished by defining method 608 as a “virtual” method and method 706 as an “override” method of the same name. This is illustrative only. The overriding effect may be accomplished in any other suitable way in other implementations.

Class 702, as generated by subsystem 102, may include multithread protection code configured to protect against multithreading problems that may otherwise occur during execution of software code including classes 602 and 702 absent the multithread protection code. To illustrate, class 702 shown in FIG. 7 includes multithread protection code 708 and 710. Multithread protection code 708 may be part of method 706 and configured to be executed when method 706 is called (either directly or indirectly by way of overriding method 608) such that method 706 is a multithread-safe method.

In the illustrated example, multithread protection code 708 is configured to marshal execution of method 608 onto a particular thread of execution associated with class 702. To this end, multithread protection code 710 may be configured to define a field in class 702 that represents a thread named “PersonClassThread” that is associated with class 702. As shown in FIG. 7, multithread protection code is part of proxy constructor 704. Accordingly, when the constructor is called to instantiate an instance of class 702, multithread protection code will create and start a thread that is specific to class 702 and that may be referred to as a “proxy thread.” Multithread protection code 708 may implement a thread marshaling interface that is configured to marshal execution of method 608 onto the proxy thread created by multithread protection code 710. For example, when executed, multithread protection code 708 may determine whether the execution of method 706 is executing on a thread other than the proxy thread created by multithread protection code 710. If the execution is on a different thread, multithread protection code 708 will marshal the execution onto the proxy thread created by multithread protection code 710 (e.g., through the use of the “personClassThread.Invoke” statement shown in FIG. 7. If the execution of method 706 is determined to be on the proxy thread already, multithread protection code 708 may call method 608 with having to first marshal the execution of method 608 from a different thread onto the proxy thread.

The above-described marshaling may be accomplished in any suitable way. In certain implementations, for example, a queue may be used. To illustrate, an execution of method 608 may be marshaled to the proxy thread by adding data representative of the execution to a queue. The proxy thread may be configured to pull executions off of the queue in order for execution on the thread.

The above-described marshaling of execution of method 608 onto a particular thread illustrates an example of constraining execution of a method to a thread associated with a class based on the class and/or a relationship to the class. Such constraint to a particular thread may be configured to ensure an order of execution of one or more methods and/or operations, which may protect against one or more multithreading problems (e.g., race conditions) that may otherwise occur absent the multithread protection code 708 and 710.

The above-described marshaling of execution of method 608 onto a particular thread illustrates just one example of multithread protection code that may be generated by subsystem 102. Other implementations of multithread protection code may be generated and implemented in other examples to protect against multithreading problems. Any suitable multithread protection strategy and/or variation thereof may be employed by the multithread protection code, including, without limitation, marshaling execution to particular threads, gating access to resources, and controlling the timing of executions.

To illustrate, from an analysis of method 608 in class 602, subsystem 102 may be configured to determine whether method 608 is a synchronous or asynchronous method. The determination may be made in any suitable way. For example, subsystem 102 may search for particular types of parameters (e.g., callbacks in the form of function pointers), other attributes that may designate the method as synchronous or asynchronous, or events defined in class 602 that correlate with a proxy version of method 608 being generated. Based on the determination as to whether method 608 is synchronous or asynchronous, subsystem 102 may generate particular multithread protection code and/or a variation of multithread protection code for inclusion in method 706. For example, if method 608 is synchronous, method 706 may be generated to be synchronous. Whereas if method 608 is asynchronous, method 706 may be generated to be asynchronous.

As mentioned, heuristic data 216 in storage facility 210 may specify one or more heuristics that may be utilized by subsystem 102 to generate appropriate multithread protection code and/or multithread-safe software code. The heuristics may define templates and/or versions of multithread protection code that may be selected by subsystem 102 based on an analysis of corresponding elements (e.g., class 602) in software code and used to generate appropriate multithread protection code. The heuristics may be defined as may suit a particular implementation.

As mentioned, software code 104 may include or otherwise represent a cochlear implant fitting software application. Accordingly, subsystem 102 may analyze a non-multithread-safe version of the fitting software application and automatically generate a multithread-safe version of the fitting software application in any of the ways described herein. The multithread-safe fitting software application may then be implemented in a fitting system and utilized to perform one or more fitting procedures configured to fit a cochlear implant system to a patient.

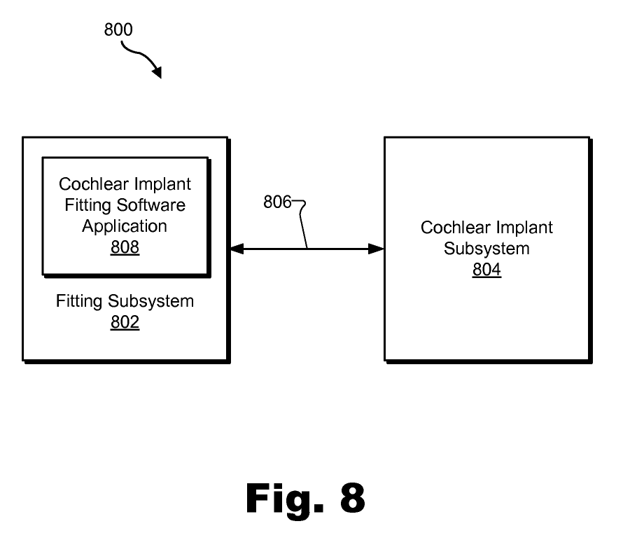

FIG. 8 illustrates an exemplary cochlear implant fitting system 800 (or simply “fitting system 800”) that may be used to fit a cochlear implant patient. As shown in FIG. 8, fitting system 800 may include a fitting subsystem 802 and a cochlear implant subsystem 804. Fitting subsystem 802 may be configured to be selectively and communicatively coupled to cochlear implant subsystem 804 by way of a communication link 806. Fitting subsystem 802 and cochlear implant subsystem 804 may communicate using any suitable communication technologies, devices, networks, media, and protocols supportive of data communications.

Cochlear implant subsystem 804 may include one or more components of a cochlear implant system configured to convert an audio signal to an electrical signal and to generate one or more stimulation signals based on the electrical signal. When applied to a patient, the stimulation signals may be configured to stimulate auditory nerve fibers of the patient to produce a perception of sound in the brain of the patient.

Fitting subsystem 802 may be configured to perform one or more fitting procedures and/or direct cochlear implant subsystem 804 to perform one or more fitting procedures to fit cochlear implant system 804 to the patient. The fitting procedures may be designed to optimize performance of cochlear implant subsystem 804 for the patient. Such fitting procedures may include, but are not limited to, adjusting one or more control parameters by which one or more components of cochlear implant subsystem 804 operate, measuring one or more electrode impedances, performing one or more neural response detection operations, and/or performing one or more diagnostics procedures associated with cochlear implant subsystem 804.

As shown in FIG. 8, fitting subsystem 802 may include a cochlear implant fitting software application 808, which may be configured to direct and/or control fitting operations of fitting subsystem 802. Cochlear implant fitting software application 808 may be implemented by fitting subsystem 802 in any suitable way, such as by storage as computer-executable instructions in a computer-readable medium and that are configured to direct at least one computing device and/or processor of fitting subsystem 802 to execute one or more fitting operations.

Cochlear implant fitting software application 808 may be automatically generated by subsystem 102 in any of the ways described herein such that cochlear implant fitting software application 808 is multithread safe. Accordingly, fitting subsystem 802 and/or a user of fitting subsystem 802 (e.g., an audiologist or the like) may benefit from one or more multithreading capabilities of cochlear implant fitting software application 808. In addition, cochlear implant fitting software application 808 may exhibit multithreading reliability that is derived from the way in which cochlear implant fitting software application 808 is automatically generated by subsystem 102 as described herein.

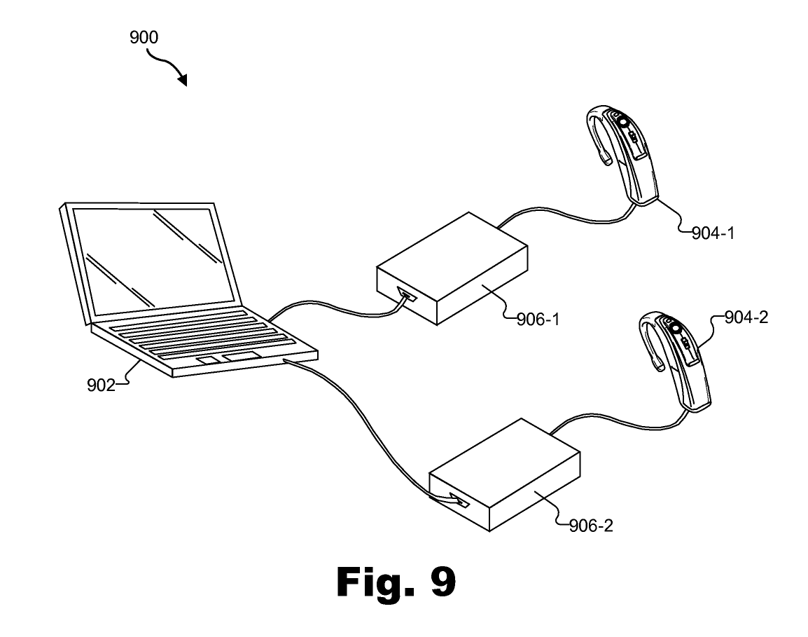

FIG. 9 illustrates an exemplary implementation 900 of fitting system 800 that may be used to fit a bilateral cochlear implant patient. In implementation 900, a fitting station 902 implementing cochlear implant fitting software application 808 may be selectively and communicatively coupled to first and second sound processor in the form of behind-the-ear (“BTE”) units 904-1 and 904-2 (collectively referred to herein as “BTE units 904”) by way of corresponding clinician programming interface (“CPI”) devices 906-1 and 906-2 (collectively referred to herein as “CPI devices 906”). BTE unit 904-1 may be associated with a first cochlear implant (e.g., a cochlear implant associated with a right ear of a patient) and BTE unit 904-2 may be associated with a second cochlear implant (e.g., a cochlear implant associated with a left ear of the patient). BTE units 904 are merely exemplary of the many different types of sound processors that may be employed by a cochlear implant system.

CPI devices 906 may be configured to facilitate communication between fitting station 902 and BTE units 904. In some examples, CPI devices 906 may be selectively and communicatively coupled to fitting station 902 and/or BTE units 904 by way of one or more ports included within fitting station 902 and BTE units 904.

Fitting station 902 may include any suitable computing device and/or combination of computing devices and may be configured to perform one or more of fitting procedures as directed by cochlear implant fitting software application 808. For example, fitting station 902 may include a laptop computer, personal computer, or any other computing device configured to operate in accordance with cochlear implant fitting software application 808.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software) embodied on a non-transitory computer-readable medium configured to perform one or more of the processes described herein. In particular, system components (e.g., subsystem 102) may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). As mentioned above, such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

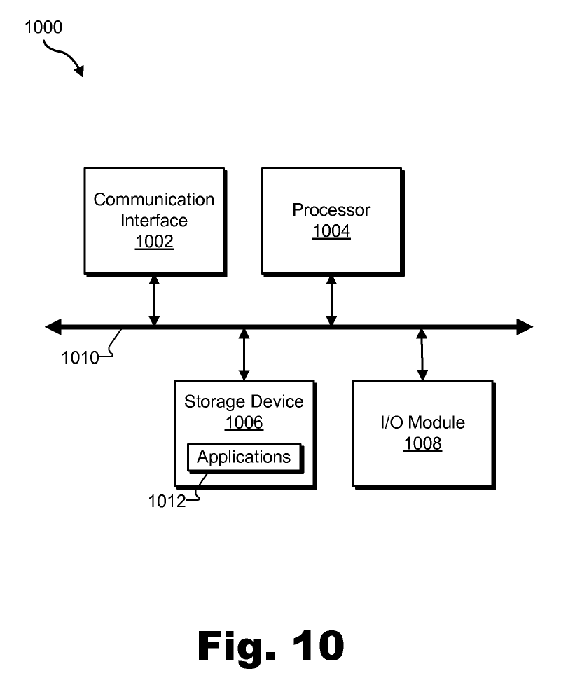

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (“I/O”) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, and any other suitable interface. Communication interface 1002 may additionally or alternatively provide such a connection through, for example, a local area network (such as an Ethernet network), a personal area network, a telephone or cable network, a satellite data connection, a dedicated URL, or any other suitable connection. Communication interface 1002 may be configured to interface with any suitable communication media, protocols, and formats, including any of those mentioned above.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another non-transitory computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1006. For example, data representative of one or more executable applications 1012 (which may include, but are not limited to, one or more of the software applications described herein) configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1000. For example, one or more applications 1012 residing within storage device 1006 may be configured to direct processor 1004 to perform one or more processes or functions associated with software interface facility 202, user interface facility 204, code analysis facility 206, and code generation facility 208. Likewise, storage facility 210 may be implemented by or within storage device 1006.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
analyzing, by a multithread-safe code generator subsystem, data representative of non-multithread-safe software code; and
automatically generating, by the multithread-safe code generator subsystem, data representative of multithread-safe software code based on the analyzing of the data representative of the non-multithread-safe software code.

2. The method of claim 1, wherein:
the analyzing comprises
detecting an element of the non-multithread-safe software code that is to be made multithread safe, and
analyzing the element; and
the automatically generating comprises generating a multithread-safe version of the element based on the analyzing of the element.

3. The method of claim 2, wherein the element comprises a class that is designated by a marker in the non-multithread-safe software code to be made multithread safe.

4. The method of claim 3, wherein the multithread-safe version of the element comprises a proxy class that derives from the class.

5. The method of claim 4, wherein the automatically generating further comprises inserting at least one multithread-safe method into the proxy class.

6. The method of claim 5, wherein the at least one multithread-safe method is configured to constrain an execution to a thread associated with the proxy class.

7. The method of claim 6, wherein the at least one multithread-safe method is configured to constrain the execution to the thread associated with the class by marshaling the execution from another thread onto the thread associated with the class.

8. The method of claim 7, wherein the marshaling comprises:
adding the execution to a queue; and
the thread associated with the class pulling the execution from the queue for execution by the thread associated with the class.

9. The method of claim 6, wherein the automatically generating further comprises generating a constructor configured to create and start the thread associated with the class.

10. The method of claim 5, wherein the multithread-safe method is designated to override a public virtual method included in the class.

11. The method of claim 2, wherein:
the analyzing further comprises detecting a call configured to instantiate an instance of the element of the non-multithread-safe software code that is to be made multithread safe; and
the automatically generating further comprises replacing the call with a new call configured to instantiate an instance of the multithread-safe version of the element.

12. The method of claim 1, wherein:
the non-multithread-safe software code comprises a non-multithread-safe version of a cochlear implant fitting software application; and
the multithread-safe software code comprises a multithread-safe version of the cochlear implant fitting software application.

13. The method of claim 1, embodied as computer-executable instructions on at least one non-transitory computer-readable medium.

14. A method comprising:
detecting, by a multithread-safe code generator subsystem, a class that is included in software code and that is to be made multithread safe;
analyzing, by the multithread-safe code generator subsystem, the class;
automatically generating, by the multithread-safe code generator subsystem based on the analyzing of the class, a proxy class that derives from the class, wherein the proxy class includes multithread protection code that is configured to make the proxy class a multithread-safe version of the class; and
implementing, by the multithread-safe code generator subsystem, the proxy class in the software code.

15. The method of claim 14, further comprising:
detecting, by the multithread-safe code generator subsystem, a call that is included in the software code and that is configured to instantiate an instance of the class; and
replacing, by the multithread-safe code generator subsystem in the software code, the call with a new call that is configured to instantiate an instance of the proxy class.

16. The method of claim 14, wherein:
the class includes a public virtual method; and
the proxy class includes a public override method that is configured to override the public virtual method to implement the multithread protection code.

17. The method of claim 14, wherein:
the proxy class is generated to include a constructor configured to create and start a proxy thread associated with the proxy class; and
the multithread protection code is configured to marshal an execution from a different thread onto the proxy thread associated with the proxy class.

18. The method of claim 14, embodied as computer-executable instructions on at least one non-transitory computer-readable medium.

19. A system comprising:
a code analysis facility configured to analyze software code representative of a non-multithread-safe version of a cochlear implant fitting software application; and
a code generation facility communicatively coupled to the code analysis facility and configured to automatically generate, based on the analysis, data representative of a multithread-safe version of the cochlear implant fitting software application.

20. The system of claim 19, wherein:
the code analysis facility is configured to analyze software code representative of a non-multithread-safe version of a cochlear implant fitting software application by
detecting an element of the non-multithread-safe version of the cochlear implant fitting software application that is to be made multithread safe,
analyzing the element, and
detecting a call configured to instantiate an instance of the element of the non-multithread-safe version of the cochlear implant fitting software application that is to be made multithread safe; and
the code generation facility is configured to automatically generate the data representative of the multithread-safe version of the cochlear implant fitting software application by
generating a multithread-safe version of the element based on the analysis of the element, and
replacing the call with a new call configured to instantiate an instance of the multithread-safe version of the element.
